(19) United States
(12) Patent Application Publication
(10) Pub. No.: US 2021/0169613 A1
(43) Pub. Date: Jun. 10, 2021

(54) APPARATUS FOR SHORTIE WIRE TIGHTENING AND/OR TWISTING/ROTATION

(71) Applicant: Ara Gulesserian, Glendale, CA (US)

(72) Inventor: Ara Gulesserian, Glendale, CA (US)

(21) Appl. No.: 17/112,659

(22) Filed: Dec. 4, 2020

Related U.S. Application Data
(60) Provisional application No. 62/943,318, filed on Dec. 4, 2019.

(51) Int. Cl. A61C 7/02; B25B 7/12

(52) U.S. Cl. CPC A61C 7/026; B25B 7/12

(57) ABSTRACT

An enhanced plier including a first handle and a second handle, a first tip and a second tip; and a hinging assembly, the first handle and the second handle connected to the hinging assembly and the first tip and the second tip connected to the hinging assembly, wherein pressing the first handle and the second handle to cause the first tip to move towards the second tip. The enhanced plier further includes a gearing assembly, the gearing assembly coupled to the first handle or the second handle. The enhanced plier further includes a lever assembly, the lever assembly coupled to the gearing assembly, wherein a movement in a first direction of the lever assembly causes engagement of the gearing assembly and rotation of gears in the gearing assembly, which causes the enhanced plier to rotate about a rotation axis.

### RELATED APPLICATIONS

This patent application claims priority to U.S. provisional patent application Ser. No. 62/943,318, filed Dec. 4, 2019, entitled “Apparatus And/Or Device For Shortie Wire Tightening And/Or Twisting/Rotation,” the disclosure of which is hereby incorporated by reference.

### FIELD OF INVENTION

This disclosure relates to a method and apparatus for use in orthodontic dental procedures, as well as other medical procedures, to first connect wires around mouth braces brackets and to then twist the wire to tighten the wire around the bracket. The wire is generally referred to as a shorty or shortie.

### BACKGROUND OF THE INVENTION

In the prior art, an orthodontal patient may have braces, wherein the braces include two or more brackets that are attached to a patient's teeth as well as connecting wires that connect the two are more brackets. In order to tighten the connecting wires to the bracket, wire shorties may be utilized to tighten the connecting wires to the bracket. Currently, a dentist utilizes Mathieu pliers to hold the wire shorty before it is placed on the bracket. The shorty may be held in place by serrations on the inside of tips or beaks of the Mathieu pliers. Then, the shorty is tightened on the bracket by squeezing the handle of the pliers, which results in the beaks or tips of the Mathieu pliers to close. The dentist then needs to twist the shorty (in either a clockwise or counterclockwise direction) in order to tighten the connecting wire onto the bracket. Currently, that requires the orthodontist to rotate their hands and wrists in order to twist the shorty in a clockwise or counterclockwise direction. Since this has to done for each bracket to which the connecting wire is attached to, the orthodontist is repeating the same motion over and over. This results in a higher incidence of carpal tunnel and other repetitive use injuries due to the repetitive twisting motion and pressure that is exerted on the orthodontist's wrist. Accordingly, a new procedure and tool is needed in order to hold the shortie, place the shortie on the bracket and then twist the shortie that does not require an orthodontist to utilize a twisting motion.

### BRIEF DESCRIPTION OF THE DRAWINGS

FIG. 1 illustrates a Mathieu plier according to the prior art;

FIG. 1B illustrates how a wire shorty is placed on a bracket according to the prior art;

FIG. 1C illustrates how a wire shorty is tightened onto a bracket 170 according to some embodiments;

FIG. 2A illustrates a block diagram of an enhanced plier for connecting and then twisting/tightening shorties according to some embodiments;

FIG. 2B illustrates an axis of rotation of the enhanced plier; and

FIG. 3 illustrates an enhanced plier for connecting and then twisting or tightening shorties according to some embodiments;

FIG. 4A illustrates a block diagram of another enhanced plier for twisting shorties according to some embodiments;

FIG. 4B illustrates a block diagram of another enhanced plier for twisting shorties according to some embodiments; and

FIG. 4C illustrates a block diagram of another enhanced plier for twisting shorties according to some embodiments.

### DETAILED DESCRIPTION

The foregoing, and other features and advantages of the invention, will be apparent from the following, more particular description of the preferred embodiments of the invention, the accompanying drawings, and the claims.

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

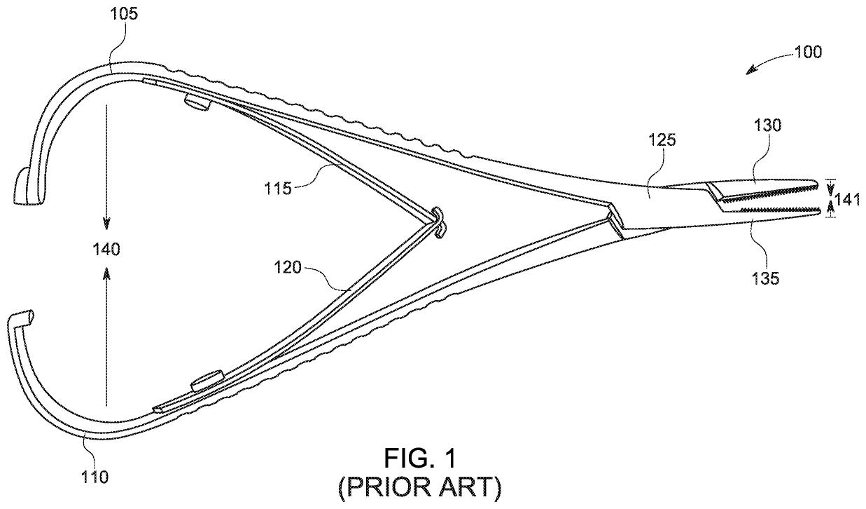

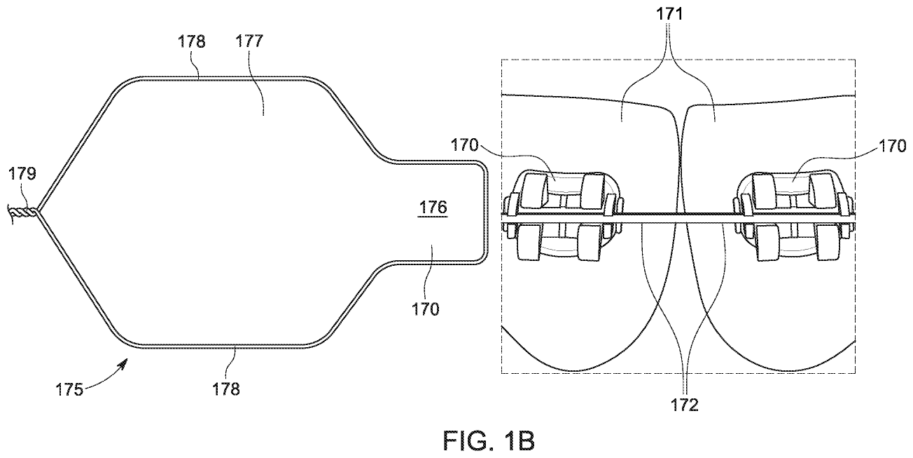

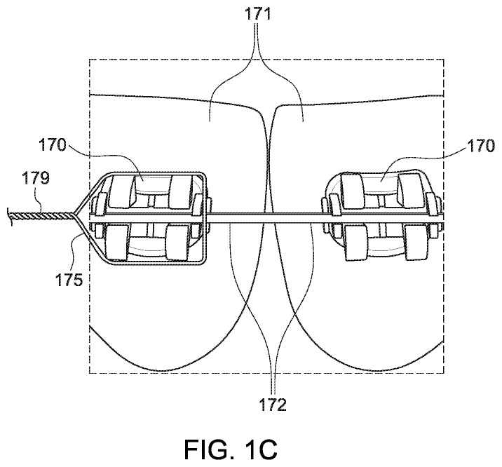

FIG. 1 illustrates a Mathieu plier device according to the prior art. The Mathieu plier is a positive locking pliers intended for holding, placing, and tying ligatures and elastics. As described above, an orthodontist may utilize Mathieu pliers to hold and twist shorties onto orthodontic braces that are attached to a patient's teeth. While the specification refers to orthodontists, this also applies to orthodontal assistants, and other technicians helping the orthodontist. The Mathieu plier 100 includes two handles 105, 110; two interconnected springs 115, 120, a hinging assembly 125 and area; and two beaks or tips 130 135. An orthodontist may grab the handles 105 110 and press in a direction 140 to close the opening in a middle of the plier and/or the handles. In some embodiments, a first end of the spring 115 may be connected to an underside of the handle 105 and a first end of the spring 120 may be connected to an underside of the handle 110. The second end of spring 115 may be connected to the second end of spring 120 in an open area of the Mathieu plier. The springs 115 and 120 may regulate or dampen the force placed on the hinging assembly 125 by the pressing of the two handles 105 110. When the two handles 105 110 are pressed together, the tips or beaks 130 and 135 may close due to the hinging assembly 125. The direction of the closing of the tips or beaks is illustrated by reference number 141 in FIG. 1. In many cases, the shortie is larger than the bracket and so the orthodontist has to make a large number of twists or rotations in order to tighten the shortie around the bracket. This puts unnecessary strain on the wrist and/or hands of the orthodontist.

FIG. 1B illustrates how a wire shorty is placed on a bracket according to the prior art. FIG. 1B illustrates two teeth 171 each with a bracket 170 installed thereon. A guide wire 172 may run between the two brackets 170 in order to connect the two brackets 170. The guide wire 172 may end at a bracket on one of the back teeth or molars of a patient. A shorty 175 may be placed around the bracket 170 in order to tighten the braces. Specifically, an opening 176 of the shorty/shortie 175 may be placed around the bracket 170. The Mathieu pliers may then grip the shorty 175 at an opposite end 179 from the opening 176. The opposite end 179 of the shorty 175 may be twisted as illustrated in FIG. 1B. The Mathieu pliers may be rotated and may twist the middle section 178 of the shorty/shortie 175 so that it becomes a twisted wire (to be similar to the opposite end 179 which is a twisted wire). FIG. 1C illustrates how a wire shorty is tightened onto a bracket 170 according to some embodiments. In some embodiments, the orthodontist utilizes the Mathieu pliers to grab the shorty wire near reference number 179 and rotates the Mathieu pliers clockwise or counterclockwise to tighten the shorty wire 175 around the bracket 170 on the patient's teeth. As a result the shorty wire is twisted and what used to be middle section 178 of the shortie becomes twisted wire, as illustrated in FIG. 1C. In some embodiments, as a result, the shorty wire/shortie 175 is tightened abound the bracket 170.

Described herein is a unique and novel apparatus and method for having one orthodontic tool (e.g., an enhanced pliers or plier) that can cause the tips or beaks to clamp down on the shortie or other wire (or move towards each other) in one mode and also rotate either clockwise or counterclockwise in another mode. Applicant utilizes the terms plier or pliers interchangeably and they refer to a tool. In some embodiments, the tips or beaks of the pliers may be in a clamped or closed position at the same time the tips or beaks are rotating in a clockwise or counterclockwise motion. This unique and novel apparatus provides an advantage over the existing Mathieu pliers because the unique and novel device only requires that the orthodontist 1) press the two handles towards each other to place the tips or beaks of the new pliers in a close or clamped position, 2) set a different mode by pressing a pin or releasing a pin to engage a rotation assembly (or using another mechanism to engage a rotation assembly), and 3) press the two handles against each other to cause the tips or beaks of the enhanced pliers (or using another mechanical assembly and/or electromechanical assembly) to rotate in a clockwise or counter clockwise motion or direction.

In some embodiments, an orthodontist may adhere brackets onto on a patient's teeth. In some embodiments, the orthodontist may place an arch wire or connecting wire which is coupled to a channel in each of the brackets and the arch wire or connecting wire is connected to each of the brackets. In some embodiments, the arch wire or connecting wire may be anchored on molars or other patient teeth that have a cap that is all the way around a patient's molar or back teeth. In some embodiments, the orthodontist may locate a shortie wire and may press down on the handle of the enhanced pliers to grip the shortie wire. In some embodiments, the orthodontist may place the shortie wire around the bracket on the patient's tooth. In some embodiments, the orthodontist may press or release a pin, or engage a lever, which may engage a rotation assembly of the enhance plier or pliers. In some embodiments, the rotation assembly or a locking assembly may lock the tips or beaks of the pliers in a closed position. In some embodiments, the orthodontist may press the handles towards each other, which may cause the tips or beaks of the pliers to rotate. In some embodiments, the rotation of the tips or beaks of the pliers (with the attached shortie) may cause the shortie to be tightened onto and/or around the bracket. In some embodiments, the orthodontist may pull on the pin or push the pin (or utilize another mechanism), which may result in the rotation of the tips or beaks of the pliers. In some embodiments, after the shortie has been tightened, the pressing of the handles may be released which allows the tips or beaks of the pliers to open up and thus be separated from the shortie.

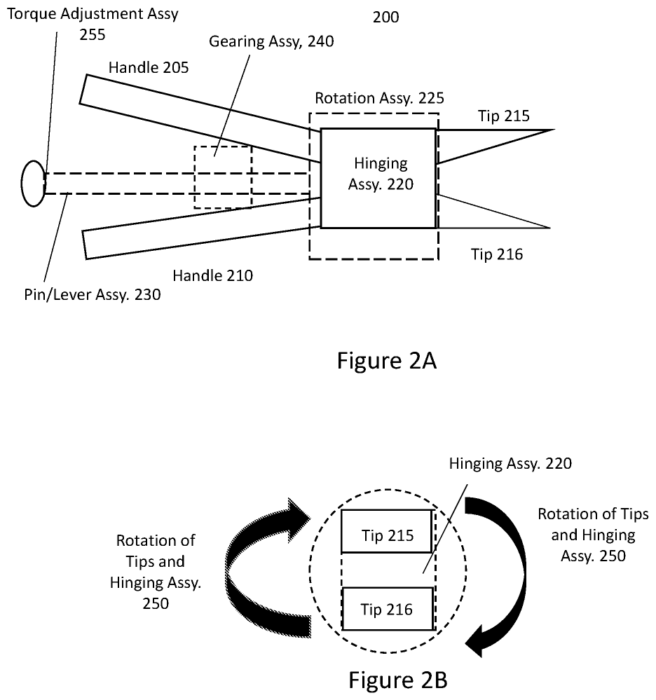

FIG. 2A illustrates a block diagram of an enhanced plier for twisting shorties according to some embodiments. In some embodiments, the enhanced plier 200 may comprise two handles 205 210, a hinging assembly 220 and/or two tips or beaks 215 and 216. In some embodiments, the enhanced plier 200 may further comprise a rotation assembly 225 and/or a pin assembly or lever assembly 230. In some embodiments, the enhanced plier 200 may also comprise a gearing assembly 240. In some embodiments, the handles 205 and 210 may be pressed towards each other. In some embodiments, in a first operating mode or a first configuration, this results in the hinging assembly 220 causing tips or beaks 215 and 216 to move towards each other. In some embodiments, this may result in the tips or beaks 215 and 215 holding and/or gripping a shorty/shortie. In some embodiments, the orthodontist may then use the enhanced plier to place the shorty/shortie on the bracket that is attached to the patient's teeth. In some embodiments, the orthodontist may then place the enhanced plier into a different operating mode or a second configuration. In the different operating mode or configuration, a rotation assembly 225 and/or a pin assembly/lever assembly 230 may lock the tips or beaks 215 and 216 in a locked position (with the shorty held in between the tip 215 and the tip 216). In the different operating mode or configuration, an orthodontist may press or push the pin assembly or lever assembly in one direction (e.g., towards or away from the rotation assembly 225). In some embodiments, in the different operating mode or configuration, the pressing of the pin assembly or lever assembly in the one direction results in rotation assembly 225 rotating in a clockwise or counterclockwise direction. In some embodiments, the rotation of the rotation assembly 225 may cause the hinging assembly 220 and/or the tips 215 and 216 (and the shorty/shortie attached between the tips 215 and 216) to also rotate in the clockwise or counterclockwise direction. In some embodiments, the axis of rotation is a line that is in the middle of the two tips 215 and 216. FIG. 2B illustrates an axis of rotation of the enhanced plier. Reference number 250 illustrates the rotation of the tips 215 and 216 and/or the hinging assembly (and thus the wire shorty/shortie held between the tips 215 and 216). In some embodiments where the gearing assembly 240 is utilized in the enhanced plier 200, an orthodontist may press on the handles 205 210 which results in the gearing assembly 240 engaging the pin assembly or lever assembly and pushing in the pin assembly or lever assembly in a first direction. In some embodiments, the pushing or movement of the pin assembly or lever assembly 230 in the first direction may cause the rotation assembly 225 to rotate. In some embodiments, in response to the rotation assembly rotating, the tips 215 and 216 and/or the hinging assembly 220 rotate (with the shorty/shortie in between the tips 215 and 216) and this results in the shorty being tightened on the bracket that is placed on the patient's teeth. In some embodiments, the torque adjustment assembly 255 may be a knob or dial and may adjust a force or length of rotation of the rotation assembly and thus the enhanced pliers.

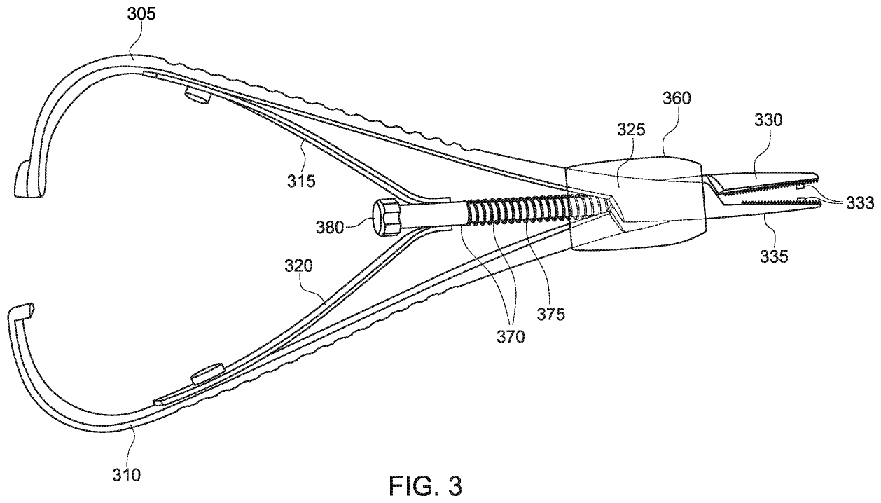

FIG. 3 illustrates an enhanced plier for connecting and then twisting or tightening shorties according to some embodiments. In some embodiments, the enhanced plier 300 may include two handles 305, 310; two springs 315, 320, an adjustment assembly 360, a hinging assembly 325 and area; and/or two beaks or tips 330 and 335. In some embodiments, the enhanced plier may also include a torque adjustment assembly 380, a pin, tube or shaft 370, and/or a spring 375. In some embodiments, an orthodontist may grab the handles 305 310 of the enhanced plier 300 and press the handles towards each other to close the opening in the middle of the pliers. In some embodiments, one end of the handle 305 may be connected to one spring 315 (the spring 315 may be connected to an underside of the handle 305) and one end of the spring 320 may be connected to an underside of the handle 310. In some embodiments, the second end of spring 315 and/or the second end of spring 320 may be connected to a first end of the pin, tube or shaft 370. In some embodiments, the springs 315 and 320 may regulate the force placed on the hinging assembly 325 that occurs by the pressing of the two handles 305 and 310. In some embodiments, when the two handles 305 and 310 are initially pressed together, the tips or beaks 330 and 335 may close due to the hinging assembly 325 and be able to grip the shortie. In many cases, the shortie has enough wire so that a large number of twists or rotations in order to tighten the shortie around the bracket on the patient's teeth. This puts unnecessary strain on the wrist and/or hands of the orthodontist. However, the present invention and claimed subject matter alleviates this strain because the orthodontist does not have to rotate his hands or wrists. In some embodiments, an orthodontist may press the handles 305 or 310 a second or subsequent time. In some embodiments, this causes the enhanced plier to move to a second configuration or second mode of operation (e.g., a rotation mode). In some embodiments, the orthodontist may set a switch or locking assembly, which puts the enhanced plier into rotation mode. In some embodiments, the orthodontist may pull or push a pin 370 in order to place the enhanced pliers into a rotation mode. In some embodiments, the subsequent or second squeeze of the handles 305 or 310 and/or the pushing or pulling of the pin 370 may cause the rotation assembly 360 to rotate in a clockwise or counterclockwise direction. In some embodiments, this may cause the tips or beaks 330 and 335 to rotate in a clockwise or counterclockwise direction (with the shortie held in between). In some embodiments, the hinging assembly 325 may also rotate. In some embodiments, the torque adjusting assembly 380 may allow an orthodontist to adjust an amount of force and/or pressing required to rotate the adjustment assembly 360 and/or a number of rotations that occur during each pressing of the handles. In some embodiments, the torque adjusting assembly 380 may rotate about the pin 370 and/or may tighten the spring 375. In some embodiments, the spring 375 may dampen a force that is applied to the adjustment assembly 360. In some embodiments, the beaks or tips of the pliers 330 or 335 may also include shorty/shortie cutting devices 333 which may be ledges (as illustrated in FIG. 3), ridges or channels where the shorty may be placed in order to be cut. In some embodiments, the shortie cutting devices 333 may cut the shortie after the shortie has been tightened about the bracket of the braces. In some embodiments, the rotation of the rotation assembly 360 (and thus the tips 330 and 335 and/or the hinging assembly 325) may be caused by pulling the pin or lever away from the tips or beaks 330 or 335 or pushing the pin towards the beaks or tips 330 or 335 rather than having the rotation of the rotation assembly 360 be caused by the pressing of the handles 305 310 toward each other. In other words, pulling and/or pushing the pin and/or lever towards or away from the beak may cause the rotation assembly to rotate. In some embodiments, when the rotation assembly rotates, the tips 330 and 335 and/or the hinging assembly 325 rotate (and thus the shortie/shorty may also rotate).

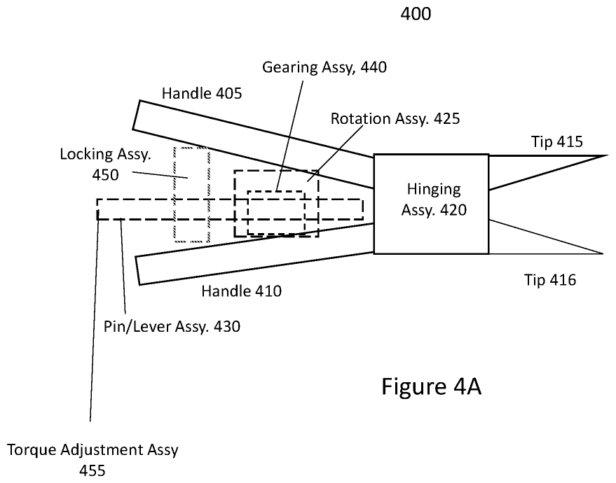

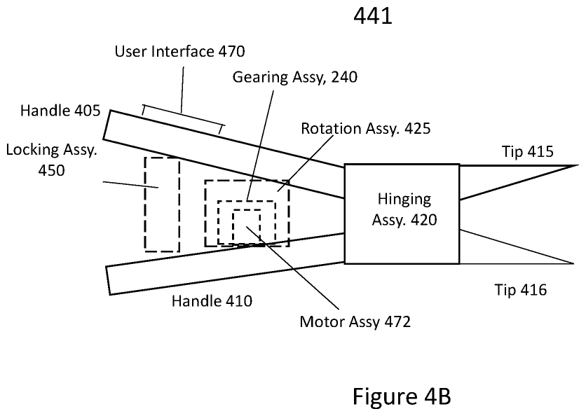

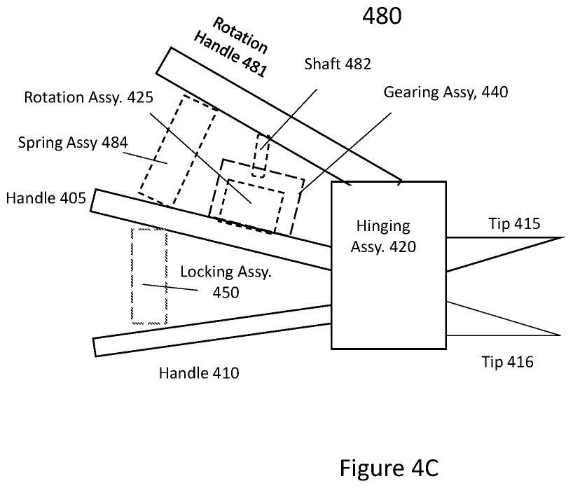

FIG. 4A illustrates a block diagram of another enhanced plier for twisting shorties according to some embodiments. In some embodiments, the enhanced plier or pliers 400 may comprise two handles 405 410, a hinging assembly 420 and/or two tips or beaks 415 and 416. In some embodiments, the enhanced plier 400 may further comprise a rotation assembly 425, a locking assembly 450, and/or a pin assembly or lever assembly 430. In some embodiments, the enhanced plier 400 may also comprise a gearing assembly 440. In some embodiments, the handles 405 and 410 may be pressed towards each other. In some embodiments, in a first operating mode or a first configuration, this results in the hinging assembly 420 causing tips or beaks 415 and 416 to move towards each other. In some embodiments, this may result in the tips or beaks 415 and 416 holding and/or gripping a shorty/shortie. In some embodiments, the orthodontist may then use the enhanced plier to place the shorty/shortie on the bracket that is attached to the patient's teeth. In some embodiments, the orthodontist may then place the enhanced plier into a different operating mode or a second configuration. In the different operating mode or configuration, a locking assembly may lock the handles 405 and 410 in a locked position which in turn may lock the tips or beaks 415 and 416 in a locked position (with the shorty held in between the tip 415 and the tip 416). In the different operating mode or configuration, an orthodontist may press or push the pin assembly or lever assembly in one direction (e.g., towards or way from the rotation assembly 425). In some embodiments, in the different operating mode or configuration, the pressing of the pin assembly or lever assembly in the one direction results in rotation assembly 425 rotating in a clockwise or counterclockwise direction. In some embodiments, the rotation of the rotation assembly 425 may cause the hinging assembly 420, the handles 405 and 410, and/or the tips 415 and 416 (and the shorty/shortie attached between the tips 415 and 416) to also rotate in the clockwise or counterclockwise direction. In some embodiments, the axis of rotation is a line that is in the middle of the two tips 415 and 416 and runs through an axis through the pin or lever assembly 430. FIG. 2B illustrates an axis of rotation of the enhanced plier. In some embodiments where a gearing assembly 440 is utilized in the enhanced plier 400, an orthodontist may press on the handles 405 410 which results in the gearing assembly 440 engaging the pin assembly or lever assembly 430 and pushing in the pin assembly or lever assembly in a first direction. In some embodiments, the pushing or movement of the pin assembly or lever assembly 430 in the first direction may cause the rotation assembly 425 to rotate. In some embodiments, in response to the rotation assembly 425 rotating, the tips 415 and 416 and/or the hinging assembly 420 rotate (with the shorty/shortie in between the tips 415 and 416) and this results in the shorty being tightened on the bracket that is placed on the patient's teeth.

FIG. 4B illustrates a block diagram of another enhanced plier for twisting shorties according to some embodiments. In some embodiments, the enhanced plier 441 may comprise two handles 405 410, a user interface module 470, a hinging assembly 420 and/or two tips or beaks 415 and 416. In some embodiments, the enhanced plier 441 may further comprise a rotation assembly 425, a locking assembly 450, a gearing assembly 440 and/or a motor assembly 472. In some embodiments, the enhanced plier 400 may also comprise a gearing assembly 440. In some embodiments, the handles 405 and 410 of the enhanced pliers may be pressed towards each other. In some embodiments, in a first operating mode or a first configuration, this results in the hinging assembly 420 causing the tips or beaks 415 and 416 to move towards each other. In some embodiments, this may result in the tips or beaks 415 and 416 holding, grasping and/or gripping a wire shorty or shortie. In some embodiments, the orthodontist may then use the enhanced plier 441 to place the shorty/shortie on the bracket that is attached to the patient's teeth. In some embodiments, the orthodontist may then place the enhanced plier into a different operating mode or a second configuration. In some embodiments, before going to a different operating mode, the orthodontist may engage a locking assembly 450 to lock the handles 405 and 410 in place. In the different operating mode or configuration, a locking assembly 450 may lock the handles 405 and 410 in a locked position which in turn may lock the tips or beaks 415 and 416 in a locked position (with the shorty held in between the tip 415 and the tip 416).

In some embodiments, after the locking assembly 450 has been engaged, an orthodontist may engage a user interface module 470. Utilizing the user interface module 470, the orthodontist may engage the motor assembly 472. In some embodiments, the motor assembly 472 may be utilized to cause the enhanced plier 441 to rotate in a clockwise or counterclockwise direction. In some embodiments, the user interface module 470 may be a switch, a button, a dial or other similar mechanisms, where the orthodontist may select a torque and/or a number of rotations that may occur with the enhanced plier or pliers. In some embodiments, the user interface module 470 may be connected via wires or wirelessly to the motor assembly in order to instruct and/or activate the motor assembly 472. In the different operating mode or configuration, an orthodontist may utilize the user interface module 470 to select desired settings for the enhanced plier 441. In order for the user interface module 470 and the motor assembly 472 to operate, there also needs to be a power supply (not shown) for the enhanced plier or pliers. In some embodiments, the power supply may be a battery or rechargeable battery. In some embodiments, the power supply may be recharged by plugging a power cable into a power interface of the enhanced plier or by removing the rechargeable power source and recharging it that way. In some embodiments, the user interface module 470 may communicate with the motor assembly 472. In some embodiment, the motor assembly 472 may be activate which may cause a motor shaft to rotate and engage the gearing assembly 440. In some embodiments, rotation of the motor shaft may cause the gearing assembly to rotate in a desired clockwise or counterclockwise direction. In some embodiments, the gearing assembly 440 may be connected, attached and/or coupled to the rotation assembly 425. Therefore, the rotation of the gearing assembly 440 may cause the rotating of the rotation assembly 425 (which in turn will cause the enhanced pliers 441 to rotate clockwise or counterclockwise). In some embodiments, the motor assembly 472 may be oriented or positioned in the enhanced plier 440 so that the motor shaft's axis of rotation is aligned with enhanced plier's axis of rotation (as shown in FIG. 2B). In other words, the axis of rotation of both may be a line running through the front center of the tips 415 and 416 and back towards the rear of the enhanced plier 441. In other embodiments, the gearing assembly 440 may utilize right angle gears or gearing assemblies in order to change the axis of rotation of the motor shaft and motor assembly to the axis of rotation of the enhanced pliers. A number of different motor shaft and/or gearing assembly configurations may be utilized to obtain the axis of rotation of the enhanced pliers shown that is shown in FIG. 2B. In some embodiments, in response to the rotation assembly 425 rotating, the tips 415 and 416 and/or the hinging assembly 420 rotate (with the shorty/shortie in between the tips 415 and 416) and this results in the shorty being tightened on the bracket that is placed on the patient's teeth. The motor assembly configuration and/or user interface module may also be utilized with the other embodiments illustrated in FIGS. 2A, 3 and 4A and 4C.

FIG. 4C illustrates a block diagram of an additional enhanced plier for twisting shorties according to some embodiments. In some embodiments, the enhanced plier 480 may comprise two handles 405 410, a locking assembly 450, a hinging assembly 420 and/or two tips or beaks 415 and 416. In some embodiments, the enhanced plier 480 may further comprise a rotation handle 481, a rotation assembly 425, a spring assembly 484, a gearing assembly 440, and a shaft 482.

In some embodiments, the handles 405 and 410 of the enhanced pliers may be pressed towards each other. In some embodiments, in a first operating mode or a first configuration, this results in the hinging assembly 420 causing the tips or beaks 415 and 416 to move towards each other. In some embodiments, this may result in the tips or beaks 415 and 416 holding, grasping and/or gripping a wire shorty or shortie. In some embodiments, the orthodontist may then use the enhanced plier 441 to place the shorty/shortie on the bracket that is attached to the patient's teeth. In some embodiments, the orthodontist may then place the enhanced plier into a different operating mode or a second configuration. In some embodiments, before going to a different operating mode, the orthodontist may engage a locking assembly 450 to lock the handles 405 and 410 in place. In the different operating mode or configuration, a locking assembly 450 may lock the handles 405 and 410 in a locked position which in turn may lock the tips or beaks 415 and 416 in a locked position (with the shorty held in between the tip 415 and the tip 416).

In some embodiments, after the locking assembly 450 has been engaged, an orthodontist may start using the enhanced plier 480 in a second mode of operation (e.g., the rotation operation). In some embodiments, the rotation handle 481 may be connected, coupled and/or attached to the top handle 405. In some embodiments, the rotation handle 481 may be connected to the top handle 405 via a spring assembly 484. In some embodiments, a rotation handle 481 may be connected, coupled or attached to a shaft 482. In some embodiments, the shaft 482 may be integrated with the rotation handle 481. In some embodiments, the shaft 482 may be connected, coupled or attached to a gearing assembly 440. In some embodiments, the gearing assembly 440 may be coupled, attached to or connected to a rotation assembly 425. In some embodiments, a rotation assembly 425 may be connected, attached or coupled to a top handle 405 of the enhanced plier or pliers. In some embodiments, in order to operate the enhanced pliers 480, the orthodontist may press the rotation handle 481 towards the top handle 405 and this may cause the shaft or rod 482 to move in a downward direction. In some embodiments, the movement of the shaft or rod 482 in a downward direction engages the gearing assembly 440. In some embodiments, the gearing assembly 440 may consist of a number of gears or gearing devices. In some embodiments, the gearing assembly 440 may include one or more right angle gearing assemblies that create an axis of rotation of the gearing assembly. In some embodiments, the insertion of the shaft or rod 482 (which may have threads on one end) into a threaded opening of the gearing assembly 440 may engage the gearing assembly. In some embodiments, the receiving of the shaft 482 causes rotation of one or more gears in the gearing assembly 440. In some embodiments, the gearing assembly 440 may then rotate in a clockwise or counterclockwise direction (with a same axis of rotation as is shown in FIG. 2B). In some embodiments, the gearing assembly 440 may rotate about a different axis of rotation after receiving the shaft, but the gears or additional gearing assemblies may change that axis of rotation to the axis of rotation of the enhanced plier or pliers (shown in FIG. 2B). Because the gearing assembly 440 is connected to the rotation assembly 425, and the rotation assembly is connected to the top handle 405, the rotation of the gearing assembly 425 causes the top handle 405 to rotate in a same direction (and thus the enhanced pliers 480 may also rotate in a clockwise or counterclockwise direction because it follows the rotation of the top handle). FIG. 2B illustrates an axis of rotation of the enhanced plier. In some embodiments, in response to the rotation assembly 425 rotating, the tips 415 and 416 and/or the hinging assembly 420 rotate (with the shorty/shortie in between the tips 415 and 416) and this results in the shorty being tightened on the bracket that is placed on the patient's teeth.

In some embodiments, an enhanced plier includes a first handle and a second handle; a first tip and a second tip; a hinging assembly, the first handle and the second handle connected to the hinging assembly and the first tip and the second tip connected to the hinging assembly, wherein pressing the first handle and the second handle to cause the first tip to move towards the second tip and a gearing assembly, the gearing assembly coupled to the first handle or the second handle. In some embodiments, the enhanced plier also includes a lever assembly, the lever assembly coupled to the gearing assembly, wherein a movement in a first direction of the lever assembly causes engagement of the gearing assembly and rotation of gears in the gearing assembly, which causes the enhanced plier to rotate about a rotation axis. In some embodiments, the enhanced plier or pliers include a rotation assembly, the rotation assembly coupled to the lever assembly, the rotating assembly rotating about the rotation axis in response to movement of the lever assembly. In some embodiments, the enhanced plier or pliers include a torque adjustment assembly, the torque adjustment assembly coupled to the lever assembly and to change a rotation force of the lever assembly. In some embodiments, the enhanced plier or pliers include a rotation assembly, the rotation assembly coupled to the gearing assembly and the lever assembly, wherein the locking assembly to lock a hinging assembly from movement and wherein movement of the lever assembly causes the gearing assembly to rotate and the rotation assembly to rotate about the rotation axis based at least in part on engagement with the gearing assembly.

In some embodiments, an enhanced plier or pliers includes a first handle and a second handle; a first tip and a second tip; a hinging assembly, the first handle and the second handle connected to the hinging assembly and the first tip and the second tip connected to the hinging assembly, wherein pressing the first handle and the second handle to cause the first tip to move towards the second tip; a rotation assembly, the rotation assembly coupled to the gearing assembly; a gearing assembly, the gearing assembly coupled to the first handle or the second handle; and a motor assembly, the motor assembly, when activated, to cause rotation of the gearing assembly, the rotation of the gearing assembly to cause rotation of the enhanced plier about a rotation axis. In some embodiments, the enhanced plier further includes a locking assembly, the locking assembly coupled to the first handle and the second handle, the locking assembly to prevent movement of the hinging assembly and the first handle with respect to the second handle. In some embodiments, the enhanced plier further includes a rotation assembly, the rotation assembly coupled to the gearing assembly, the rotation assembly to rotate about the rotation axis upon engagement with the gearing assembly. In some embodiments, the enhanced plier further includes a user interface module, the user interface module to allow selection of parameters for amount of rotations or force of rotations by the gearing assembly or the rotation assembly, the user interface module to communicate the selected parameters to the motor assembly to cause activation of the motor assembly.

In some embodiments, an enhanced plier or pliers include a first handle and a second handle; a first tip and a second tip; a hinging assembly, the first handle and the second handle connected to the hinging assembly and the first tip and the second tip connected to the hinging assembly, wherein pressing the first handle and the second handle to cause the first tip to move towards the second tip; a rotation assembly, the rotation assembly coupled to the gearing assembly; a gearing assembly, the gearing assembly coupled to the first handle or the second handle; a rotation handle, the rotation handle being connected to the first handle via a spring assembly; and a shaft connected or coupled to the rotation handle. In this embodiment, pressing the rotation handle towards the first handle results in downward movement of the shaft wherein the shaft engages the gearing assembly and causes the gearing assembly to rotate and the rotation of the gearing assembly causes the rotation assembly, and the first tip, the second tip and the hinging assembly, to rotate. In some embodiments, the enhanced pliers further include a locking assembly to prevent movement of the first handle with respect to the second handle

A number of embodiments have been described. Nevertheless, it will be understood that various modifications may be made without departing from the spirit and scope of the invention. For example, much of this document has been described with respect to a wristwatch form factor, but other forms of devices may be addressed.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The above disclosure is sufficient to enable one of ordinary skill in the art to practice the invention, and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. An enhanced plier, comprising:
a first handle and a second handle;
a first tip and a second tip;
a hinging assembly, the first handle and the second handle connected to the hinging assembly and the first tip and the second tip connected to the hinging assembly, wherein pressing the first handle and the second handle to cause the first tip to move towards the second tip;
a gearing assembly, the gearing assembly coupled to the first handle or the second handle; and
a lever assembly, the lever assembly coupled to the gearing assembly, wherein a movement in a first direction of the lever assembly causes engagement of the gearing assembly and rotation of gears in the gearing assembly, which causes the enhanced plier to rotate about a rotation axis.

2. The enhanced plier of claim 1, further comprising:
a rotation assembly, the rotation assembly coupled to the lever assembly, the rotating assembly rotating about the rotation axis in response to movement of the lever assembly.

3. The enhanced plier of claim 1, further comprising a torque adjustment assembly, the torque adjustment assembly coupled to the lever assembly and to change a rotation force of the lever assembly.

4. The enhanced plier of claim 1, further comprising:
a locking assembly coupled to the first handle and to the second handle;
a rotation assembly, the rotation assembly coupled to the gearing assembly and the lever assembly,
wherein the locking assembly to lock a hinging assembly from movement and
wherein movement of the lever assembly causes the gearing assembly to rotate and the rotation assembly to rotate about the rotation axis based at least in part on engagement with the gearing assembly.

5. An enhanced plier, comprising:
a first handle and a second handle;
a first tip and a second tip;
a hinging assembly, the first handle and the second handle connected to the hinging assembly and the first tip and the second tip connected to the hinging assembly, wherein pressing the first handle and the second handle to cause the first tip to move towards the second tip;
a rotation assembly, the rotation assembly coupled to the gearing assembly;
a gearing assembly, the gearing assembly coupled to the first handle or the second handle; and
a motor assembly, the motor assembly, when activated, to cause rotation of the gearing assembly, the rotation of the gearing assembly to cause rotation of the enhanced plier about a rotation axis.

6. The enhanced plier of claim 5, further comprising a locking assembly, the locking assembly coupled to the first handle and the second handle, the locking assembly to prevent movement of the hinging assembly and the first handle with respect to the second handle.

7. The enhanced plier of claim 5, further comprising a rotation assembly, the rotation assembly coupled to the gearing assembly, the rotation assembly to rotate about the rotation axis upon engagement with the gearing assembly.

8. The enhanced plier of claim 5, further comprising a user interface module, the user interface module to allow selection of parameters for amount of rotations or force of rotations by the gearing assembly or the rotation assembly, the user interface module to communicate the selected parameters to the motor assembly to cause activation of the motor assembly.

10. An enhanced plier, comprising:
a first handle and a second handle;
a first tip and a second tip;
a hinging assembly, the first handle and the second handle connected to the hinging assembly and the first tip and the second tip connected to the hinging assembly, wherein pressing the first handle and the second handle to cause the first tip to move towards the second tip;
a rotation assembly, the rotation assembly coupled to the gearing assembly;
a gearing assembly, the gearing assembly coupled to the first handle or the second handle;
a rotation handle, the rotation handle being connected to the first handle via a spring assembly; and
a shaft connected or coupled to the rotation handle,
wherein pressing the rotation handle towards the first handle results in downward movement of the shaft,
wherein the shaft engages the gearing assembly and causes the gearing assembly to rotate and the rotation of the gearing assembly causes the rotation assembly, and the first tip, the second tip and the hinging assembly, to rotate.

10. The enhanced plier of claim 9, further comprising:
a locking assembly to prevent movement of the first handle with respect to the second handle.
